(19) United States
(12) Patent Application Publication
(10) Pub. No.: US 2017/0292827 A1
(43) Pub. Date: Oct. 12, 2017

(54) COORDINATE MEASURING SYSTEM

(71) Applicant: Carl Zeiss Industrielle Messtechnik GmbH, OBERKOCHEN (DE)

(72) Inventor: Nils HAVERKAMP, AALEN (DE)

(21) Appl. No.: 15/484,825

(22) Filed: Apr. 11, 2017

(30) Foreign Application Priority Data
Apr. 12, 2016 (DE) 10 2016 106 696.6

(51) Int. Cl. G01B 11/00; G06T 7/73; G06T 7/60; G01B 11/26

(52) U.S. Cl. CPC G01B 11/002; G01B 11/26; G06T 7/73; G06T 7/60

(57) ABSTRACT

A system for measuring spatial coordinates of a measurement object, comprising a mobile computer device comprising a first optical sensor for capturing image data of the measurement object; a pose determination unit comprising an external tracking sensor, wherein the external tracking sensor is embodied separately from the mobile computer device and is configured to capture pose data indicative of a pose of the mobile computer device; and a control unit configured to determine the spatial coordinates of the measurement object on the basis of the image data of the measurement object and the pose data of the mobile computer device.

### CROSS-REFERENCES TO RELATED APPLICATIONS

This application claims Convention priority of German patent application 10 2016 106 696.6, filed on Apr. 12, 2016. The entire content of this priority application is incorporated herein by reference.

### BACKGROUND OF THE INVENTION

The disclosure relates to a system for measuring spatial coordinates of a measurement object. The system according to this disclosure may also be referred to as a mobile optical coordinate measuring machine.

Coordinate measuring machines serve for checking workpieces, for example as part of quality assurance, or for ascertaining the geometry of a workpiece as part of what is known as “reverse engineering.” Moreover, diverse further application possibilities are conceivable, such as e.g. process-controlling applications, too, in which the measurement technique is applied directly for online monitoring and regulation of manufacturing and processing processes.

In coordinate measuring machines, different types of sensors may be used to capture the workpiece to be measured. By way of example, sensors that measure in tactile fashion are known in this respect, as are sold by the applicant under the product designation “VAST XT” or “VAST XXT”. Here, the surface of the workpiece to be measured is scanned with a stylus, the coordinates of said stylus in the measurement space being known at all times. Such a stylus may also be moved along the surface of a workpiece in a manner such that a multiplicity of measurement points can be captured at set time intervals during such a measurement process as part of a so-called “scanning method”.

Moreover, it is known to use optical sensors that enable non-contact capture of the coordinates of a measurement object or workpiece. The present disclosure relates to such a coordinate measuring machine or coordinate measuring system comprising an optical sensor.

In optical dimensional metrology, great outlays regularly arise if the form of measurement objects or workpieces is intended to be measured with accuracies in the range of single micrometers. This is generally attributable to the fact that comparatively complex and heavy sensors are guided by comparatively complex machines along preplanned trajectories. Subsequently or in parallel, the optically captured information is then related to the spatial information provided by the machine actuator system, such that the surface of the object to be measured can be reconstructed. One example of such an optical sensor is the optical sensor sold by the applicant under the product designation “ViScan”. An optical sensor of this type can be used in various types of measurement setups or coordinate measuring machines. Examples of such coordinate measuring machines are the products “O-SELECT” and “O-INSPECT”, which are sold by the applicant.

The issue of the mobile usability of such coordinate measuring machines is increasingly gaining in importance since this would extend the spectrum of use of the coordinate measuring machines even further just on account of the more flexible usability. However, the extremely stringent requirements made in terms of the measurement accuracy that these coordinate measuring machines are intended to deliver often militate against the mobile usability of such a coordinate measuring machine. It is true that manifold digital-optical possibilities now exist, in particular software methods, in order that, from images or films of objects or scenes, the spatial structure of the imaged objects in the scene may be deduced. For this purpose, a 3D point cloud is usually generated computationally from the image or video material. Many of these possibilities are even accessible at no cost. In principle, however, these methods have some deficiencies which have the consequence that they are currently still not appropriate for the highly accurate measurements demanded. The most serious factor is achieving the measurement accuracy required for industrial applications.

In the digital-optical methods known heretofore, which involve the use of conventional photographic or video apparatuses, for example, achieving the demanded measurement accuracy is usually not possible, in particular for the following reasons: A simple calibration of “imaging scales” is ruled out since the optical units used for imaging in mobile terminals, but also in expensive cameras, are not designed for metrological purposes. Inter alia, they are generally not telecentric, which leads to unquantifiable, defocus-dependent imaging scale variations during operation. Their deformations and distortions are generally unknown and, under certain circumstances, not reproducible during the operation of the optical unit. This is applicable particularly if video or photographic apparatuses with moving zoom and/or autofocus optical units are involved.

One possible solution would consist in adding reference objects of known size to the scene. This would enable a calibration of the imaging conditions that were present when the respective image was recorded. Particularly for the measurement of relatively large parts, however, this reference object would then have to be taken along concomitantly. Alternatively, a large number of reference objects would have to be available. Both are impractical if only from a workflow standpoint.

A further problem is achieving high accuracy over relatively large measurement distances. The approaches are based in principle on so-called stitching, i.e. correlative methods for determining the offset of the individual images of an image sequence. This approach leads in principle to the possibility of measurement errors increasing without limit and in addition is greatly restricted regarding achievable accuracies if the imaging aberrations vary within the image sequence. Moreover, the stability of the correlation calculation is influenced greatly by the image content. As regards the measurement of feature-poor objects as represented by, for example, cleanly manufactured small drilled holes in groove-free surroundings, which then typically also have to be measured accurately, these are particularly poor image contents for correlative methods.

### SUMMARY OF THE INVENTION

It is thus an object to provide a coordinate measuring system, that is to say a system for measuring spatial coordinates of a measurement object, which overcomes the disadvantages mentioned above. In this case, it is an object, in particular, to provide a solution which is capable of mobile use and is comparatively cost-effective and which nevertheless makes it possible to be able to ensure the measurement accuracy required for the industrial metrology.

In accordance with one aspect of the present disclosure, a system for measuring spatial coordinates of a measurement object is provided, comprising:
a mobile computer device comprising a first optical sensor for capturing image data of the measurement object;
a pose determination unit comprising an external tracking sensor, wherein the external tracking sensor is embodied separately from the mobile computer device and configured to capture pose data indicative of a pose of the mobile computer device; and
a control unit configured to determine the spatial coordinates of the measurement object based on the image data of the measurement object and the pose data of the mobile computer device.

In accordance with a further aspect of the present disclosure, a method is provided comprising the following steps:
providing a mobile computer device comprising a first optical sensor;
capturing image data of the measurement object by means of the first optical sensor;
capturing pose data indicative of a pose of the mobile computer device by means of a pose determination unit comprising an external tracking sensor, wherein the external tracking sensor is embodied separately from the mobile computer device; and
determining the spatial coordinates of the measurement object on the basis of the image data of the measurement object and the pose data of the mobile computer device.

As far as the essential component parts of the herein presented system are concerned, said system is similar to a commercially available optical coordinate measuring machine insofar as here, too, the three customary modules: sensor system, actuator system and control unit are used for generating the 3D information of the measurement object.

In contrast to the customary optical coordinate measuring machines, the sensor system for capturing the data of the measurement object comprises a mobile computer device and a pose determination unit having an external tracking sensor, which is configured to capture data with regard to the pose of the mobile computer device, i.e. the position and location of the mobile computer device. The mobile computer device is equipped with an optical sensor, which is designated as “first optical sensor” in the present case for differentiation from further optical sensors. Said first optical sensor is preferably a camera that can be used to gather image data from the measurement object and, if appropriate, also the environment thereof. Said image data may comprise one or a plurality of images or an entire image sequence, that is to say also a video. The mobile computer device is preferably a tablet computer, a smartphone or a laptop. In principle, however, other mobile terminals are also appropriate.

In comparison with a conventional optical coordinate measuring machine, the herein presented system does not have an actuator controlled in an automated manner. Instead, in the present system the human acts as an actuator, moving the sensor, i.e. the mobile computer device with the camera arranged thereon (first optical sensor), relative to the measurement object. However, since the human cannot provide information in the micrometers range with regard to the movement thereof, the position and location information (pose data) of the mobile computer device is generated via the already mentioned external tracking sensor of the pose determination unit. With the aid of said external tracking sensor, which is embodied separately from the mobile computer device, the position and location of the mobile computer device in space is known at every point in time during the movement of said mobile computer device.

In a manner similar to that in the case of conventional optical coordinate measuring machines, the processing of the image data captured from the measurement object and also of the pose data of the mobile computer device is effected in a control unit, which calculates the spatial coordinates of the measurement object on the basis of said data. Said control unit preferably comprises a processor on which corresponding metrological software is implemented, with the aid of which said data can be evaluated and the spatial coordinates of the measurement object can be calculated on the basis thereof. Moreover, the control unit preferably has the possibility of retrieving predefined test plans or of storing the progression of a measurement carried out together with the results thereof in a manner such that they are retrievable again.

The performance or the demanded measurement accuracy is achieved in particular by virtue of the fact that the spatial position and location of the image recording component, i.e. of the mobile computer device, are known unambiguously at any time, since they are captured unambiguously by the pose determination unit of the system.

The fact that for example a conventional tablet computer can be used as a mobile computer device affords not only the advantages already mentioned above regarding the very mobile usability of the herein presented system, but also enormous cost advantages compared with conventional optical coordinate measuring machines. Nevertheless, an accuracy of the measurement of the measurement object in the range of one or a few micrometers can be achieved with the aid of the herein presented system.

In a refinement, the control unit is configured to assume the measurement object to be time-invariant when evaluating the image data of the measurement object to determine the spatial coordinates.

In other words, the metrological software implemented on the control unit contains an algorithm which, in the evaluation of said image and pose data, assumes the measurement object itself to be time-invariant. Together with the fact that the spatial position and location (pose) of the mobile computer device and thus also the spatial position and location (pose) of the first optical sensor are known at any time, this additional input information or condition makes it possible to correct imaging differences in the individual images captured from the measurement object (for example a magnification caused by a relatively small distance between the mobile computer device and the measurement object) and also imaging aberrations such as e.g. distortions. A very accurate 3D reconstruction of the measurement object can thus be created from the image data captured from the measurement object.

The control unit can be integrated either directly into the mobile computer device or at least partly on an external computer or server that is connected to the mobile computer device via a corresponding data connection. A partial or total integration of the control unit into an external computer or server has the following advantages in comparison with its integration into the mobile computer device: A possibly limited performance of the mobile computer device is then of smaller significance. An increased power demand, which often leads to the mobile computer device heating up, can thus be prevented as well. This is advantageous particularly because instances of sensor heating, which are often accompanied by deformations, are extremely disadvantageous for metrological applications. Moreover, rechargeable battery power of the mobile computer device can also be saved. The communication of the data between the mobile computer device of the pose determination unit and the control unit can be effected both in a wired fashion and wirelessly.

In a further refinement, the external tracking sensor of the pose determination unit comprises a second optical sensor, wherein the pose data of the mobile computer device comprise image data of a monitoring region including the mobile computer device.

Preferably, said second optical sensor comprises two stationary cameras. These two stationary cameras are preferably arranged offset with respect to one another in space, such that 3D image data can be put together from the image data obtained by said cameras in a known manner. Alternatively, said second optical sensor may also comprise more than only two cameras or be realized as a 3D camera, for example a stereo camera, a plenoptic camera or a TOF camera.

In a further refinement, the pose determination unit furthermore comprises an internal position and/or location capture sensor, which is integrated into the mobile computer device and is configured to capture further data with regard to position and/or location of the mobile computer device, wherein the control unit is configured to determine the spatial coordinates of the measurement object also on the basis of the data captured by the internal position and/or location capture sensor.

Therefore, in this refinement, the pose of the mobile computer device is determined not only via the external sensor, but also with the aid of further sensors integrated into the mobile computer device. Measurement accuracy, measurement speed and long-term stability can thereby be increased. Examples of such internal position and/or location capture sensors are: a GPS/GLONASS sensor, a gyrometer, one or more acceleration sensors, a barometer, etc. Such sensors are already contained in commercially available tablet computers. By way of example, speed and location of the mobile computer device can be calculated by single or double integration of the data of an acceleration sensor integrated into the mobile computer device. Similar evaluations are possible via a gyrometer which is integrated into the mobile computer device and which can be used to ascertain angles and/or locations in space and angular velocities of the mobile computer device. By comparison, temporal, spatial and/or Fourier frequency filtering and/or Kalman filtering and/or other methods for so-called sensor data fusion of the measurement values of the individual sensors of the pose determination unit, it is thus possible simultaneously to increase the accuracy and the measurement speed of the capture of the pose of the mobile computer device.

In accordance with a further refinement, the mobile computer device furthermore comprises a third optical sensor for capturing image data from the environment of the mobile computer device, wherein the control unit is configured to identify at least one stationary reference point in the image data captured by the third optical sensor and to ascertain the position and location of said reference point with regard to the mobile computer device, and wherein the control unit is configured to determine the spatial coordinates of the measurement object also on the basis of the ascertained position and location of the at least one identified reference point relative to the mobile computer device.

The first and the third optical sensors, which are both integrated into the mobile computer device, preferably each comprise a camera. The camera of the first sensor and the camera of the third sensor preferably have opposite viewing directions. The mobile computer device preferably additionally comprises a display. The viewing direction of the camera of the first sensor is preferably opposite to the emission direction of the display. By contrast, the camera of the third sensor is preferably arranged on an opposite side with respect to the camera of the first sensor, that is to say preferably on the same side of the mobile computer device as the display.

In the refinement mentioned last, the third optical sensor is thus likewise part of the pose determination unit. Preferably, in particular the location of the mobile computer device in space is determined with the aid of the evaluation of the image data captured by the third optical sensor. For support, 2D or 3D objects which are stably localizable and easily recognizable for image-processing algorithmic procedures can also be added to the object space in order to be able better to ascertain spatial relations in the image data.

In a further refinement, the control unit is configured to determine whether the external tracking sensor is imaged in the image data captured by the third optical sensor.

With the aid of this evaluation, it is possible to check whether the external tracking sensor, that is to say for example the two stationary cameras for externally determining the pose of the mobile computer device, have a free view of the mobile computer device. Consequently, it would be possible to recognize, for example, if one or both stationary cameras of the external tracking sensor temporarily cannot optically capture the mobile terminal at all, since for example a human or an object is obstructing the field of view. The control unit may be configured not to use, or to use only in part, the image data of the external tracking sensor for the determination of the spatial coordinates of the measurement object if, on the basis of the image data captured by the third optical sensor, it is ascertained that the external tracking sensor is not imaged or is only partly imaged in said image data. In this case, therefore, data of one or both stationary cameras of the tracking sensor which at times do not optically capture the mobile computer device would not be taken into account in these time intervals. As a result, the bandwidth or computing power can be saved and the stability of the so-called position fix can also be increased.

In a further refinement, the mobile computer device comprises a display and an optical marker, wherein the optical marker either is arranged fixedly on the mobile computer device or is generated on the display, and wherein the control unit is configured to determine the pose of the mobile computing device with the aid of the optical marker.

With the aid of one such optical marker or with the aid of a plurality of such optical markers, the pose of the mobile computer device can be determined even more precisely on the basis of the image data obtained by the external tracking sensor. The markers may be binary or black-white, grayscale-gradated or else colored structures. These structures can be identified with the aid of the cameras of the tracking sensor relatively simply in the image data thereof, such that a tracking of said markers in space can be ensured relatively simply. The optical markers may be static or variable markers.

In embodiment refinement, the control unit is configured to generate the optical marker on the display and to vary a representation and/or position of the optical marker on the display over time.

Such a temporal variation of the markers has a number of advantages: Firstly, it is thereby possible to synchronize parts of the system according to the invention with one another. Secondly, the structures represented on the display can be adapted variably to the external conditions.

In invention refinement, the control unit is configured to vary the representation and/or position of the optical marker on the display depending on the pose data determined by the pose determination unit.

A modification of the marker structures represented on the display depending on the pose data of the mobile computer device has the particular advantage that the optical marker is adaptable variably to the changing viewing direction for the external tracking sensor, such that the external tracking sensor can determine the pose of the mobile computer device with uniformly high measurement accuracy. Also in this case, the pose data may comprise the data determined by the external tracking sensor and the data determined by the internal position and/or location capture sensor(s).

In a further refinement, the control unit is configured to synchronize the image data of the measurement object captured by the first optical sensor with the image data of the monitoring region captured by the second optical sensor, on the basis of the temporally varied representation and/or position of the optical marker.

Further possibilities for synchronizing the captured data include access to universal time. In this case, however, both the second optical sensor or the external tracking sensor and the mobile computer device would have to have access to the universal time clock. Even though commercially available tablet computers normally have such access to the universal time clock anyway, this would necessitate a further data connection for the external tracking sensor. A synchronization as presented above with the aid of the temporally varied representation and/or position of the optical marker on the display is thus significantly more elegant and more autonomous.

In accordance with a further refinement, the first optical sensor comprises a telecentric optical unit or plenoptic optical unit, which is integrated into the first optical sensor or is arranged in a releasable manner on the latter.

The second variant of a releasable arrangement, for example with the aid of a clip-on optical unit, is preferred in the present case since the mobile computer device does not have to be permanently modified for this purpose. Such clip-on optical units are advantageous particularly for cases in which the reproducibilities of the imaging relationships of the moving optical units of the mobile computer device are not sufficient to be able to achieve the desired accuracies. For these cases a clip-on optical unit could be designed such that the optical unit in the mobile computer device need no longer be adjusted. That is to say that possible desired changes, e.g. in the working distance and/or the magnification, would be transferred to the clip-on optical unit. This adjustable optical unit is preferably controlled via the mobile computer device or the control unit. Clip-on optical units can also be used for the display of the mobile computer device, as will also be explained in detail further below.

In accordance with a further refinement, the system furthermore comprises an illumination device for illuminating the measurement object, wherein the control unit is configured to control the illumination device in such a way that the latter periodically changes its brightness.

Such an illumination device is advantageous particularly if the ambient illumination or the display luminous intensity of the mobile computer device does not suffice to be able to measure sufficiently rapidly and/or accurately. A periodic change in brightness, that is to say for example a blinking or flashing of the illumination device, has the following advantages: a relatively low energy consumption; and shorter shutter times for the recordings of the scenes by the mobile computer device, such that the recordings of the first optical sensor, for example, are less blurred if the mobile computer device is moved during the capture of the image data. Moreover, less heat is generated, which is always advantageous in metrological applications.

With the use of such an illumination device it is advantageous if the display of the mobile computer device is at least partly antireflection-coated. This ensures that the external tracking sensor can identify entirely satisfactorily the above-mentioned markers that are generated on the display.

In principle, however, it is also possible to use a spectral and/or temporal separation of the image recordings and/or of the tracking of the position and location of the mobile computer device and/or of the ambient illumination. In this case, the possibility is then also afforded of separately optimizing the illumination and imaging conditions for the two measurement tasks (capturing image data from the measurement object and capturing image data from the mobile computer device).

Furthermore, it is possible to use the display of the mobile computer device for illuminating the measurement object. By way of example, the control unit may be configured to drive the display in such a way that a stripe projection is imaged on the measurement object. Further possibilities for the optimized illumination of the measurement object are explained in greater detail further below with reference to the figures.

In a further refinement, the mobile computer device furthermore comprises a loudspeaker and/or a vibration actuator, wherein the control unit is configured to drive the vibration actuator and/or to output information via the display and/or the loudspeaker depending on the image data captured by the first optical sensor and/or depending on the data captured by the pose determination unit.

In measurement applications in which the display faces the user, besides the optical markers mentioned above it is also possible to represent supporting optical information for the user on the display. Said information may include e.g. feedback messages as to whether enough image data have already been captured for the 3D reconstruction of the measurement object. Likewise, by means thereof it is also possible to pass on instructions to the user that support the latter regarding for what parts of the measurement object image data must still be captured in order to completely capture said measurement object. Parts of the display may, if appropriate, also be provided for the control of the system via a touchscreen function. Alternatively, a control of the system may also be effected by voice control via built-in microphones. Further supporting information can also be communicated to the user acoustically via the loudspeaker. Since, in the present use, the user moves the mobile computer device preferably using his/her hands, the output of vibration signals is particularly advantageous since this directly appeals to the sense of touch that is used by the user anyway in this activity. The control unit may be configured to support the user when implementing a predefined test plan. In this regard, said control unit may instruct the user e.g. with regard to the positions “to be moved to”, and it may give feedback messages optically, acoustically and/or haptically in the course of measurement operation. Said feedback messages for the user may concern e.g. error messages, achieved accuracies, permissible speeds or measurement distances, etc.

It is understood that the aforementioned features and those yet to be explained below may be used not only in the respectively specified combination but also in other combinations or on their own, without departing from the spirit and scope of the present disclosure. It should likewise be pointed out that the abovementioned embodiments described essentially in relation to the herein presented system relate in a corresponding manner to the herein presented method.

### BRIEF DESCRIPTION OF THE DRAWINGS

Exemplary embodiments of the invention are shown in the drawings and are explained in greater detail in the following description. In the figures:

FIG. 1 shows a schematic illustration of a first exemplary embodiment of the system according to the disclosure;

FIG. 2 shows a first exemplary embodiment of a mobile computer device which can be used in the system according to the disclosure;

FIG. 3 shows a second exemplary embodiment of the mobile computer device;

FIG. 4 shows a schematic illustration of the system according to the disclosure in a further exemplary application;

FIG. 5 shows a block diagram for schematically illustrating the components of the system according to the disclosure in accordance with one exemplary embodiment;

FIG. 6 shows a block diagram for schematically illustrating the components of the system according to the disclosure in accordance with a further exemplary embodiment; and

FIG. 7 shows a block diagram for schematically illustrating the components of the system according to the disclosure in accordance with a further exemplary embodiment.

### DESCRIPTION OF PREFERRED EMBODIMENTS

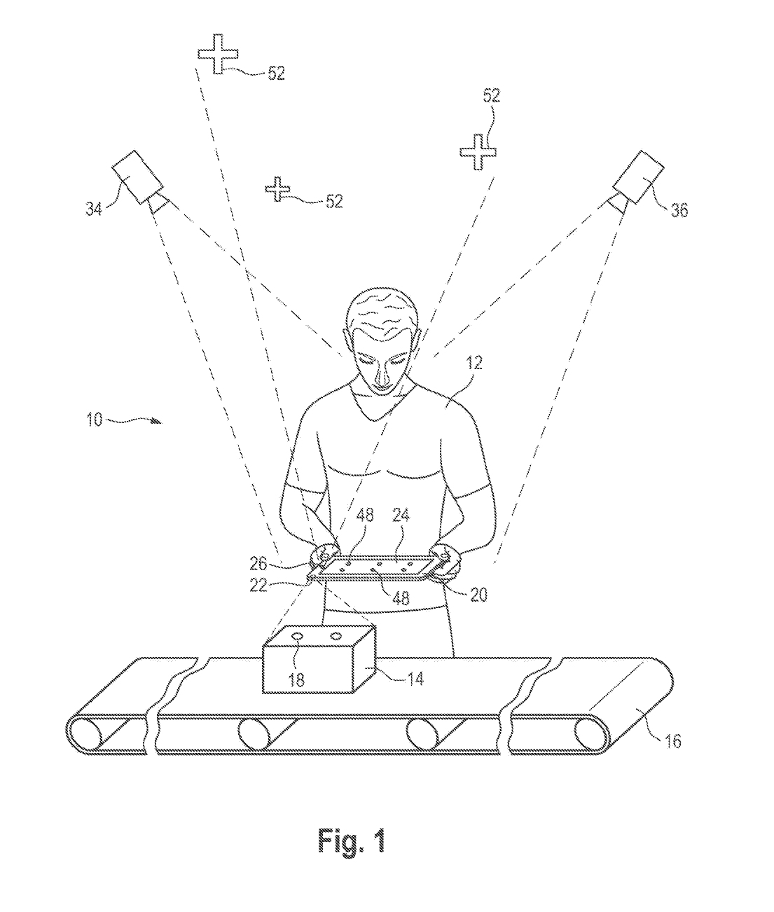

FIG. 1 shows a system in accordance with one exemplary embodiment of the present disclosure. The system is designated therein in its entirety by the reference numeral 10.

The system 10 is illustrated schematically in FIG. 1 on the basis of the example of one possible case of application. A user 12 of the system 10, e.g. a manufacturing employee, measures therein a measurement object 14 with the aid of the system 10. The measurement object 14 is, for example, a workpiece (here with two schematically illustrated drilled holes) which is situated on a conveyor belt 16 in front of the user 12. The measurement task to be performed by the user involves for example determining the diameter of the drilled hole 18 present in the measurement object 14. In addition, part of the measurement task may be to measure the flatness of the surface in which the drilled hole 18 is situated.

Instead of a large, structurally complex, relatively immobile measurement set-up of a coordinate measuring machine usually used for such tasks, the system 10 according to the disclosure for measuring the spatial coordinates of the measurement object 14 is comparatively small and capable of mobile use. The system 10 comprises a mobile computer device 20. Said mobile computer device 20 is preferably a tablet computer. By way of example, it is possible to use an iPad Air 2 WiFi plus cellular™, since this device combines a large number of the functions which are required for the system 10 according to the disclosure and are explained below. In principle, however, the use of a smartphone or laptop is also conceivable.

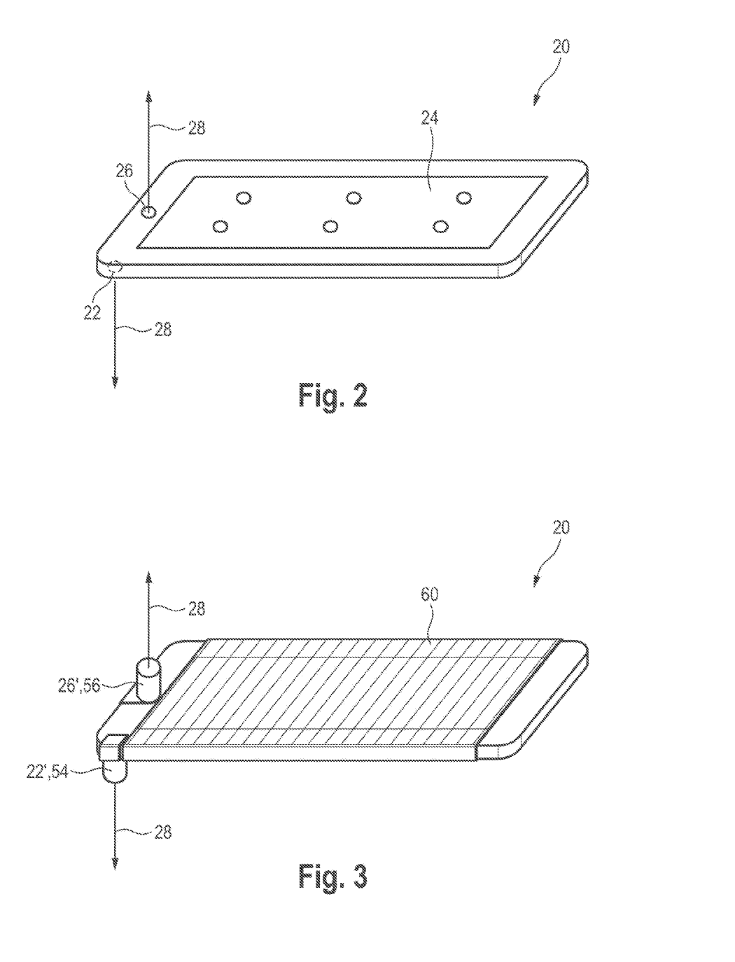

A first exemplary embodiment of such a mobile computer device 20 is illustrated schematically in FIG. 2. It comprises a first optical sensor 22, which can be used to capture image data of the measurement object 14. The first optical sensor 22, which is preferably embodied as a camera, is preferably suitable both for capturing individual images (photographs) and for capturing entire image sequences (videos). “Image data” are thus understood to be either individual images or entire image sequences.

In the present exemplary embodiment, the mobile computer device 20 furthermore also comprises a display 24 and a further optical sensor 26, which is designated as third optical sensor 26 in the present case. The third optical sensor 26 is preferably arranged on the same side of the mobile computer device 20 as the display 24. By contrast, the first optical sensor 22 is preferably arranged on the opposite side, such that the optical sensors 22, 26 have opposite viewing directions, as is illustrated schematically with the aid of the arrows 28 (see FIG. 2).

A further component part of the system 10 according to the disclosure is a pose determination unit 30 comprising a tracking sensor 32 for capturing data with regard to the position and location of the mobile computer device 20. Said tracking sensor 32 is embodied as an external tracking sensor, that is to say that it is not integrated into the mobile computer device 20, but rather tracks the position and location thereof externally. The external tracking sensor 32 preferably comprises one or more cameras. In the exemplary embodiment illustrated schematically in FIG. 1, the external tracking sensor 32 comprises two cameras 34, 36, which are installed as stationary cameras in the space and are directed at the processing station or the mobile computer device 20. Said cameras 34, 36 thus capture image data of a monitoring region in which the mobile computer device 20 is also situated. From said image data it is possible to ascertain, as explained in greater detail further below, the position and location of the mobile computer device 20 and thus also the position and location of the first optical sensor 22. It goes without saying that, instead of two cameras 34, 36, in principle three or more cameras may also be part of the external tracking sensor 32. Equally, it is also conceivable to use just a single camera, for example a 3D camera.

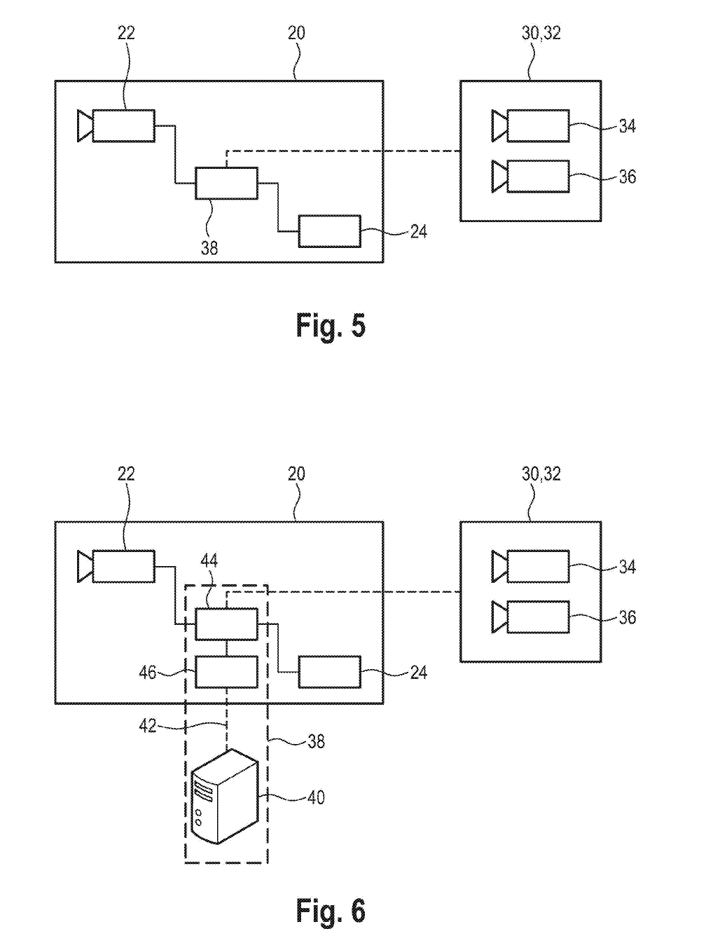

FIG. 5 shows a block diagram which schematically illustrates the fundamental components of the system according to the disclosure and their interconnection. In addition to the components already mentioned, the system 10 according to the disclosure comprises a control unit 38. In the exemplary embodiment illustrated schematically in FIG. 5, the control unit is embodied as an internal component of the mobile computer device 20. The control unit 38 preferably comprises a processor or computer chip on which corresponding image evaluation and control software is installed. Moreover, the control unit 38 preferably contains nonvolatile memories or technology for wired or wireless access to such memories in order to be able to store or retrieve again data relevant to the measurements, such as results, test plans, parameter definitions, etc., in a machine-readable manner. Besides data storage, if appropriate, outsourced processing of calculations may also be effected (cloud computing). The control unit 38 is configured to determine the spatial coordinates of the measurement object 14 on the basis of the image data of the measurement object ascertained by the first optical sensor 22 and also on the basis of the data ascertained by the external tracking sensor 32 or the cameras 34, 36 with regard to the position and location of the mobile computer device 20. The following boundary conditions are important for this type of determination of the spatial coordinates of the measurement object 14: It goes without saying that the first optical sensor 22 is a calibrated sensor. The latter should be calibrated at least insofar as its aperture angle is unambiguously known, such that later the pixel distances ascertained in the image data can be converted into real distances. It is furthermore assumed that the position and location of the mobile computer device 20 can be ascertained at every point in time with the aid of the image data captured by the cameras 34, 36, for example with the aid of known triangulation methods. A further advantageous boundary condition is the assumption that the measurement object 14 is temporally invariant, i.e. is a rigid and motionless body.

Therefore, the spatial position and location (pose) of the image recording system 20 are thus known unambiguously and at every point in time since they are supplied by the external tracking sensor 32. The additional assumption of the time invariance of the measurement object 14 then allows correction of the imaging differences (such as e.g. different working distance and hence magnification or reduction) and the imaging aberrations (such as e.g. distortion) in the individual images of an image sequence that are supplied by the first optical sensor 22, and creation of a continuous and accurate 3D reconstruction of the measurement object 14 from the entire corrected image sequence. For this purpose, by way of example, at least two images are recorded from the measurement object 14 with the aid of the first optical sensor 22, wherein these two images are recorded in different positions and/or locations of the mobile computer device 20 and thus also of the first optical sensor 22. The position and location of the mobile computer device 20 (and thus also of the first optical sensor 22) at the point in time of capturing the two images mentioned can be ascertained exactly on the basis of the image data obtained by the cameras 34, 36. Size and position changes of the imaging of the measurement object 14 from one of the two images to the other can then be linked with the ascertained position and location change of the first optical sensor 22, such that ultimately the real dimensions within the two images captured by the first optical sensor 22 can be determined unambiguously as a result. The control unit 38 is preferably configured ultimately to calculate a 3D point cloud of the measurement object 14 with the aid of the method mentioned above, wherein the coordinates of these points can be represented in an unambiguously defined, known coordinate system. Measurements with an accuracy in the range of one or a few micrometers are possible in this way.

Instead of an embodiment of the control unit 38 as a component completely integrated into the mobile computer device 20, an embodiment is likewise conceivable in which at least parts of the control unit 38 and/or of the data storage are implemented in an external computer or in a cloud. FIG. 6 shows such an embodiment in a schematic block diagram. The control unit 38 therein is not only integrated into the mobile computer device 20 but also transferred to an external server 40. Said external server 40 can be connected via a data connection 42 to the internal control unit 44 of the mobile computer device 20. The coupling can be effected for example via a data interface 46 of the mobile computer device 20. The data connection 42 may be either a wired connection or a wireless connection. The external server 40 may be either a real server or a virtual server (cloud) that can be accessed via the internet or some other network.

The exemplary embodiment illustrated in FIG. 6 has the advantage in comparison with the exemplary embodiment illustrated in FIG. 5 that a large part of the computational effort occurs outside the mobile computer device 20. This not only saves rechargeable battery power, but also prevents excessive heating of the mobile computer device 20. Avoiding such excessive heating of the computer device 20 is of immense importance in the present case in particular since relatively great temperature changes can lead to measurement errors of the first optical sensor 22.

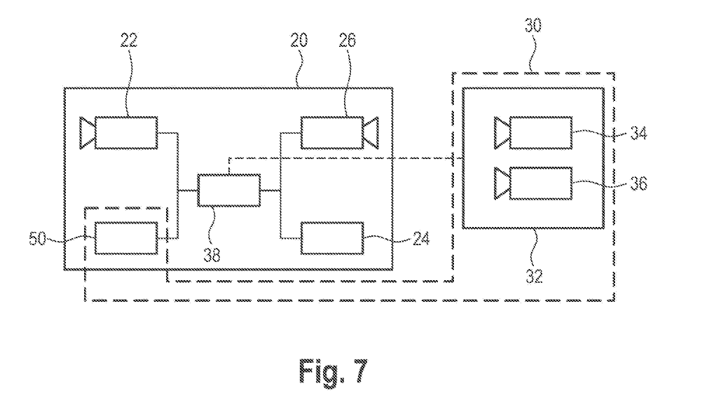

The above-explained measurement principle of the system 10 according to the disclosure can be optimized with regard to the precision thereof with the aid of a multiplicity of further system features. In order to simplify the optical capture of the position and location of the mobile computer device 20, for example a plurality of optical markers 48 can be represented on the display 24. In accordance with one exemplary embodiment of the present disclosure, the shape and/or position of said optical markers 48 on the display 24 can be changed in a predefined manner over time. This enables for example an automated, temporal synchronization of the external tracking sensor 32 (cameras 34, 36) and of the mobile computer device 20 with the first optical sensor 22 incorporated therein. Likewise, it is also possible, however, to change the optical markers 48 represented on the display 24 depending on the position and location of the mobile computer device 20. For this purpose, the mobile computer device 20 preferably comprises an internal pose determination sensor 50 (see FIG. 7), which together with the external tracking sensor 32 can be used as the pose determination unit 30. The data supplied by this internal position and location sensor 50 can be used not only for making the measurement more precise but also, in the example mentioned above, for changing the position and/or shape of the optical markers 48. This has the advantage that the optical markers 48 would thus be adaptable in such a way that they can be optimally identified by the cameras 34, 36 at any point in time.

FIG. 7 shows a block diagram which schematically illustrates an exemplary embodiment of the type mentioned last wherein the pose determination unit 30 comprises not only the external tracking sensor 32 but also an internal pose determination sensor 50. A multiplicity of possible sensors are appropriate as internal pose determination sensors 50, e.g. a gyrometer, an acceleration sensor, a GPS sensor, a barometer, etc. It goes without saying that, according to the disclosure, the mobile computer device 20 can also comprise a plurality of these pose determination sensors 50.

In comparison with the embodiments illustrated schematically in FIGS. 5 and 6, the mobile computer device 20 in accordance with the exemplary embodiment illustrated in FIG. 7 also comprises the third optical sensor 26, already mentioned further above, in addition to the first optical sensor 22. Said third optical sensor can be used essentially for the following functions in the system 10 according to the disclosure: The environment of the mobile computer device 20 can be observed with the aid of the third optical sensor 26. By way of example, it is thereby possible to identify one or a plurality of stationary reference points 52 (see FIG. 1) on the basis of which the position and location determination of the mobile computer device can be made even more precise by means of evaluation of the image data obtained with the aid of the third optical sensor 26.

A further possibility for application of the third optical sensor 26 in the system 10 according to the disclosure is as follows: The image data captured by the third sensor 26 can also be evaluated as to whether the cameras 34, 36 are visible in said image data. The consideration on which this type of evaluation is based consists in the fact that lack of visibility of the cameras 34, 36 in the image data captured by the third optical sensor 26 is a strong indication that the cameras 34, 36 also do not have an unrestricted view of the mobile computer device 20. If such a case is detected, the control unit 38 can discard the corresponding image data of one or both cameras 34, 36. This saves data capacity and increases the robustness of the position and location determination.

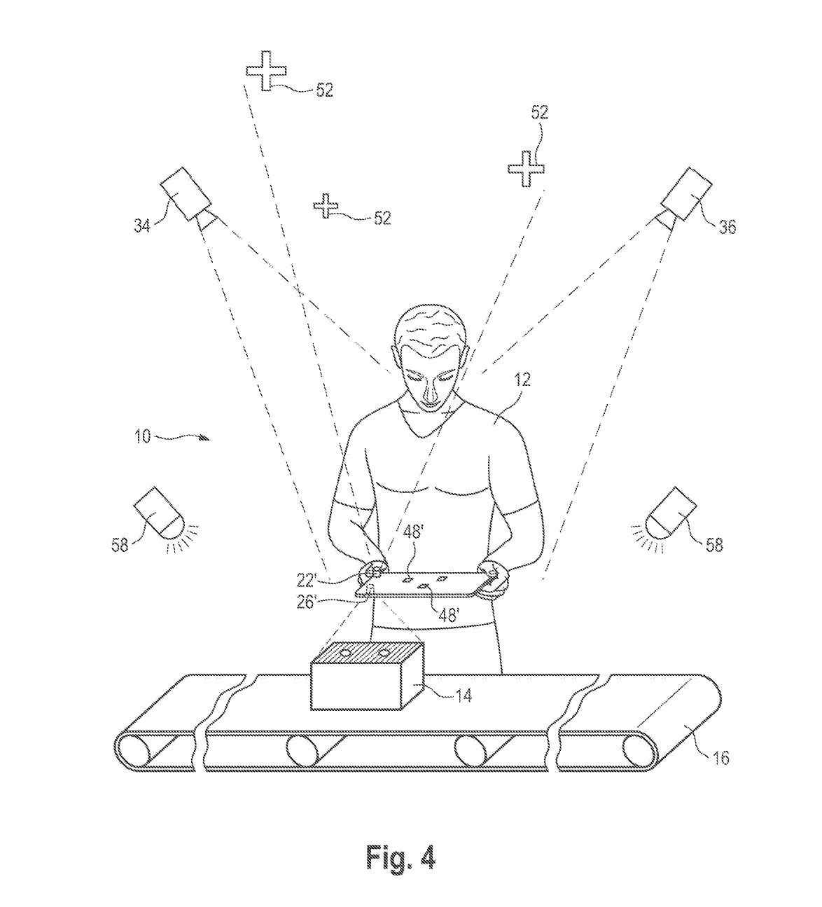

Further exemplary embodiments of the mobile computer device 20 and of the system 10 according to the disclosure are illustrated schematically in FIGS. 3 and 4. The first optical sensor 22′ and the third optical sensor 26′ are provided therein for example with additional optical units 54, 56, which can preferably be arranged in a releasable manner on the mobile computer device 20. Said optical units 54, 56 may be so-called clip-on optical units, for example, which can be pushed or clipped onto the optical sensors 22′, 26′ of the mobile computer device 20. This is conceivable particularly in cases in which the reproducibilities of the imaging conditions of the optical units 22, 26 of the mobile computer device 20 are not sufficient to be able to achieve the desired accuracies. For these cases, the clip-on optical units can be designed such that the optical unit in the mobile computer device 20 need no longer be adjusted. That is to say that possible desired changes, e.g. with regard to the working distance and/or the magnification, would be transferred to the clip-on optical unit. The control of this adjustable clip-on optical unit is preferably effected via the mobile computer device 20 or the control unit 38 or 44 thereof. Necessary algorithms, for example for assessment of contrast, sharpness and illumination, may likewise already be contained in said clip-on optical units e.g. in a machine-readable manner or ID chips may be installed, such that algorithms, calibration parameters, etc. that are relevant to the operation of the respective optical unit can be retrieved by a server or from a memory.

In particular telecentric clip-on optical units 54, 56 are advantageous for metrological applications or dimensional measurement. Telecentric optical units fundamentally differ from the customary optical units installed in mobile computer devices 20. Objects are imaged with a distance-independent scale by telecentric optical units. This is ideal for the measurement since uncertainties in the positioning of the imaging system do not translate into uncertainties of the imaging scale which directly limit the achievable measurement accuracy.

Furthermore, the clip-on optical units 54, 56 can also be configured such that a so-called plenoptic or light field recording becomes possible with the sensors 22′, 26′ of the mobile computer device 20. Particularly chips having an extremely high number of pixels (greater than 40 MPx), such as are becoming increasingly widespread in many mobile computer devices 20, offer a good basis for this. The “transformation” of the normal terminal cameras 22, 26 into a plenoptic camera has the advantage that the computer device 20 is directly able to generate 3D information about the measurement object 14 from individual recordings. Accordingly, with the use of a plenoptic camera in combination with the spatial and location ascertaining effected by the external tracking sensor 32, there is an increase in the stability and/or accuracy of the measurement with the aid of the system 10 according to the disclosure by means of which the 3D contour of the imaged measurement object 14 is reconstructed from the image data.

Furthermore, as indicated schematically in FIG. 4, it may be advantageous if the system according to the disclosure furthermore comprises one or a plurality of illumination devices 58. By way of example, a clip-on optical unit 54 can be placed onto the first optical sensor 22′, a stereoscopy module realized via color-selective optics (red/blue) being integrated into said clip-on optical unit. In this exemplary application, the illumination device 58 may be configured to illuminate the measurement object 14 in a spatially and/or temporally modulated manner, e.g. in a red and blue striped manner.

Instead of or in addition to the clip-on optical units 54, 56 pushed onto the sensors 22′, 26′, a corresponding clip-on optical unit 60 can also be placed onto the display 24 (see FIG. 3). Such a clip-on optical unit may be designed for example in a holographic fashion, in a refractive fashion, in a diffractive fashion, in a specularly reflective fashion, in a color-sensitive fashion, in a polarization-sensitive fashion or as a combination thereof. A clip-on optical unit 60 would likewise be conceivable which alternatively or supplementarily comprises a combination of Fresnel optics and micro-optics by which the light emerging from the display 24 is firstly focused cell by cell and then directed under the display-side camera lens 26′, 56. Instead of a large working distance and a large field of view, the third optical sensor 26′ in this case can then be adapted to a smaller working distance and a smaller field of view, but a larger resolution. By progressively switching on the individual illumination cells in the display 24 and recording the images that respectively arise in this case, resolution-enhancing methods, so-called angular illumination methods, become accessible. By way of example, a so-called ptychographic sensor can thus be realized. All directions of incidence could be realized by rotating the mobile computer device 20 about an axis parallel to the viewing direction 28 of the camera 26′. In this case, accurate movement of the mobile computer device 20 is not necessary since the position and location thereof are externally captured simultaneously by the external tracking sensor 32. Using this or other so-called angular illumination methods, it is possible to overcome resolution limitations of the generally low-aperture optical units of such mobile computer devices 20.

With the aid of such clip-on optical units 60 it would also be possible to use the display 24 as illumination for the measurement object 14. This is illustrated schematically in the situation depicted in FIG. 4. In comparison with the situation illustrated in FIG. 1, the user 12 holds the mobile computer device 20 the other way round, that is to say with the display 24 facing in the direction of the measurement object 14. A type of striped projection could then be projected onto the measurement object 14 via the display 24, this projection being advantageous particularly in a measurement of the flatness of surfaces. It goes without saying that, in the situation illustrated in FIG. 4, the third optical sensor 26′ is used instead of the first optical sensor 22′ for capturing the image data of the measurement object 14. Instead, in this situation it is possible to use the first optical sensor 22′ for identifying the reference points 52 and thus for ascertaining the position and location of the mobile computer device 20. In this case, the optical markers 48′ are preferably realized as static optical markers that are arranged fixedly on the mobile computer device 20. Said optical markers, as already mentioned further above, serve for simplified identification of the mobile computer device within the image data of the external tracking sensor 32 that are captured by the cameras 34, 36.

Further sensors of the mobile computer device 20 may support the system 10 according to the disclosure as follows: The identity of the user 12 can be captured via a face recognition or fingerprint sensor. If appropriate, as a result it is possible to load preset user parameters from archives. The identity of the user 12 may equally well be stored together with the measurement results in corresponding databases in an automated manner. Furthermore, it is possible to capture the motor characteristics or idiosyncrasies of the user 12 in order, depending thereon, to examine the quality of the measurement results or speeds of measurements and to relate the latter to use and/or trajectory parameters and/or environmental parameters. Measurement sequences can possibly be optimized as a result. Feedback messages or instructions can equally well be passed on to the user 12 by being output acoustically with the aid of a loudspeaker or being passed on to the user 12 in tactile form with the aid of vibration actuators or being displayed to the user 12 via the display 24.

Overall, a multiplicity of application possibilities are thus conceivable with the system 10 according to the disclosure. The system 10 according to the disclosure essentially affords the advantage, however, that a relatively exact coordinate measuring machine which is exceptionally capable of mobile use can be simulated with commercially available standard components.

What is claimed is:

1. A system for measuring spatial coordinates of a measurement object, comprising:
a mobile computer device comprising a first optical sensor for capturing image data of the measurement object;
a pose determination unit comprising an external tracking sensor, wherein the external tracking sensor is embodied separately from the mobile computer device and configured to capture pose data indicative of a pose of the mobile computer device; and
a control unit configured to determine the spatial coordinates of the measurement object based on the image data of the measurement object and the pose data of the mobile computer device.

2. The system as claimed in claim 1, wherein the control unit is integrated into the mobile computer device.

3. The system as claimed in claim 1, further comprising an external computer device, on which at least part of the control unit is implemented, wherein the external computer device is connected via a data connection to the pose determination unit and the mobile computer device.

4. The system as claimed in claim 1, wherein the control unit is configured to assume the measurement object to be time-invariant when evaluating the image data of the measurement object to determine the spatial coordinates.

5. The system as claimed in claim 1, wherein the external tracking sensor comprises a second optical sensor, and wherein the pose data of the mobile computer device comprise image data of a monitoring region including the mobile computer device.

6. The system as claimed in claim 5, wherein the second optical sensor comprises two stationary cameras.

7. The system as claimed in claim 1, wherein the pose determination unit furthermore comprises an internal position and/or location capture sensor, which is integrated into the mobile computer device and is configured to capture data with regard to position and/or location of the mobile computer device, and wherein the control unit is configured to determine the spatial coordinates of the measurement object also on the basis of the data captured by the internal position and/or location capture sensor.

8. The system as claimed in claim 1, wherein the mobile computer device furthermore comprises a third optical sensor for capturing image data of the environment of the mobile computer device, wherein the control unit is configured to identify at least one stationary reference point in the image data of the environment of the mobile computer device and to determine a position and location of said reference point relative to the mobile computer device, and wherein the control unit is configured to determine the spatial coordinates of the measurement object also on the basis of the determined position and location of the at least one identified reference point relative to the mobile computer device.

9. The system as claimed in claim 8, wherein the control unit is configured to determine whether the external tracking sensor is imaged in the image data captured by the third optical sensor.

10. The system as claimed in claim 5, wherein the mobile computer device comprises a display and an optical marker, and wherein the control unit is configured to determine the pose of the mobile computer device within the image data of the monitoring region by means of the optical marker.

11. The system as claimed in claim 10, wherein the optical marker is arranged fixedly on the mobile computer device.

12. The system as claimed in claim 10, wherein the control unit is configured to generate the optical marker on the display.

13. The system as claimed in claim 12, wherein the control unit is configured to vary a representation and/or position of the optical marker on the display over time.

14. The system as claimed in claim 13, wherein the control unit is configured to vary the representation and/or position of the optical marker on the display depending on the pose data of the mobile computer device.

15. The system as claimed in claim 13, wherein the control unit is configured to synchronize the image data of the measurement object captured by the first optical sensor with the image data of the monitoring region captured by the second optical sensor, on the basis of the temporally varied representation and/or position of the optical marker.

16. The system as claimed in claim 1, wherein the first optical sensor comprises a telecentric optical unit or a plenoptic optical unit.

17. A method for measuring spatial coordinates of a measurement object, comprising the following steps:
providing a mobile computer device comprising a first optical sensor;
capturing image data of the measurement object by means of the first optical sensor;
capturing pose data indicative of a pose of the mobile computer device by means of a pose determination unit comprising an external tracking sensor, wherein the external tracking sensor is embodied separately from the mobile computer device; and
determining the spatial coordinates of the measurement object on the basis of the image data of the measurement object and the pose data of the mobile computer device.
